(19) United States
(12) Patent Application Publication
(10) Pub. No.: US 2005/0138575 A1
(43) Pub. Date: Jun. 23, 2005

(54) Information processing apparatus with display

(76) Inventors: Kazunari Hashimoto, Tokyo (JP); Satoshi Kaneko, Saitama (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/960,681

(22) Filed: Oct. 7, 2004

(30) Foreign Application Priority Data
Dec. 19, 2003 (JP) P2003-422351

(51) Int. Cl. G06F 3/00; G06F 17/21

(52) U.S. Cl. 715/815; 715/542; 715/798; 715/860; 715/821

(57) ABSTRACT

An information processing apparatus comprises a display which is capable of displaying a display area thereon, and the display area is associated with a running program and is either active or inactive. The information processing apparatus also comprises a first user interface to detect an event representing a request to adjust a sizing of content displayed within the display area, a second user interface to receive data indicating a position of a pointer when the first user interface detects the event, and a control unit configured to adjust the sizing of the content in response to detection of the event by the first user interface in the case that the pointer's position that the second user interface receives is in the display area, regardless of whether the display area is active or inactive.

### CROSS-REFERENCE TO RELATED APPLICATIONS

This application is based upon and claims the benefit of priority from Japanese Patent Application No. 2003-422351, filed Dec. 19, 2003, the entire contents of which are incorporated herein by reference.

### BACKGROUND

1. Field

Embodiments of the present invention relate to a display control technique in an information processing apparatus such as a personal computer.

2. Description of the Related Art

Generally, an information processing apparatus, such as a personal computer for example, has a software-based window system capable of displaying a plurality of windows on a display screen thereof. Each window is a specified display area on the screen. Each window has a work region, and images such as characters and pictures provided by a running application program corresponding to the window are displayed in the work region.

The software-based window system enables each window to be resized, and each window to move on the display screen. As the technique for resizing the window, an apparatus for changing the size of a window depending on the manipulation of a mouse button is known (for example, see Japanese Patent Application Publication (KOKAI) No. 2000-293287). In this apparatus, while the mouse button is being pressed, the window size is gradually magnified or reduced along with the lapse of the time.

However, even if the window size is magnified, the display size of the content (characters, pictures, images, etc.) displayed in the window is not changed. Accordingly, if the display size of the content displayed in the window is small, in spite of magnifying the window size, the ease of seeing the characters, pictures, images, etc. displayed in the window is not improved.

In a software-based window system capable of displaying a plurality of windows at the same time, the user often manipulates for data input in a certain window while observing the content displayed in other windows. Under this condition, the certain window is active, but the other windows are inactive. To change the sizing of the content in the inactive window, such window is needed to be active first. Therefore, it is not simple to magnify or to reduce the content displayed in an arbitrary window, especially an inactive window, in this software-based window system.

### BRIEF DESCRIPTION OF THE SEVERAL VIEWS OF THE DRAWINGS

The accompanying drawings, which are incorporated within and constitute a part of the specification, illustrate embodiments of the invention, and together with the detailed description of the embodiments given below, serve to explain the principles of the invention.

FIG. 1 is a perspective view showing the outer appearance of an information processing apparatus according to a first embodiment of the invention;

FIG. 2 is an exemplary block diagram showing the system configuration of a computer according to the first embodiment;

FIG. 3 is an exemplary diagram showing configuration of a zooming utility program executed by the computer according to the first embodiment;

FIG. 4 is an exemplary diagram showing an example of an application reference table used in the computer according to the first embodiment;

FIG. 5 is an exemplary diagram showing an example of a command definition table used in the computer according to the first embodiment;

FIG. 6 is an exemplary diagram showing an example of a display screen of the computer according to the first embodiment;

FIG. 7 is an exemplary diagram showing a mode in which display contents in the window on the display screen of FIG. 6 are magnified by depressing manipulation of a magnifying button according to the first embodiment;

FIG. 8 is an exemplary diagram showing an example of the display screen of the computer according to the first embodiment;

FIG. 9 is an exemplary diagram showing a mode in which display contents in the window on the display screen of FIG. 8 are reduced by depressing manipulation of a reducing button according to the first embodiment;

FIG. 10 is an exemplary diagram showing an example of the display screen of the computer according to the first embodiment;

FIG. 11 is an exemplary diagram showing a mode in which a desktop display image on the display screen of FIG. 10 is magnified by depressing manipulation of the magnifying button according to the first embodiment;

FIG. 12 is an exemplary diagram showing an example of the display screen of the computer according to the first embodiment;

FIG. 13 is an exemplary diagram showing a mode in which a desktop display image on the display screen of FIG. 12 is reduced by depressing manipulation of the reducing button according to the first embodiment;

FIG. 14 is an exemplary flow chart showing the procedure of adjusting process executed by the computer according to the first embodiment;

FIG. 15 is an exemplary flow chart showing the procedure of process of detecting a window positioned beneath a mouse cursor, the process being executed by the computer according to the first embodiment;

FIG. 16 is an exemplary flow chart showing another example of the procedure of process of detecting a window positioned beneath a mouse cursor executed by the computer according to the first embodiment;

FIG. 17 is an exemplary diagram showing an example of the display screen of the computer according to a second embodiment of the invention;

FIG. 18 is an exemplary diagram showing a mode in which display contents in the window and the window size on the display screen of FIG. 17 are magnified by depressing manipulation of the magnifying button diagram showing an example of the display screen of the computer according to the second embodiment;

FIG. 19 is an exemplary diagram showing an example of the display screen of the computer according to the second embodiment;

FIG. 20 is an exemplary diagram showing a mode in which display contents in the window and the window size on the display screen of FIG. 19 are reduced by depressing manipulation of the reducing button according to the second embodiment; and

FIG. 21 is an exemplary flow chart showing another example of the procedure of adjusting process executed by the computer according to the second embodiment.

### DETAILED DESCRIPTION

Various embodiments according to the present invention will be described hereinafter with reference to the accompanying drawings. In general, according to one embodiment of the invention, an information processing apparatus comprises a display which is capable of displaying a display area thereon, the display area being associated with a running program and being either active or inactive. The information processing apparatus further comprises a first user interface to detect an event representing a request to adjust a sizing of content displayed within the display area, a second user interface to receive data indicating a position of a pointer when the first user interface detects the event, and a control unit configured to adjust the sizing of the content in response to detection of the event by the first user interface in the case that the pointer's position that the second user interface receives is in the display area, regardless of whether the display area is active or inactive.

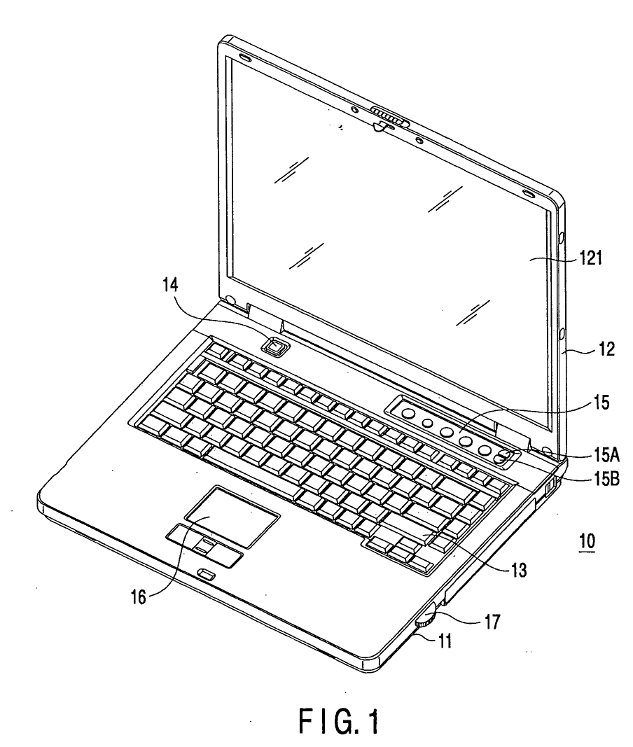

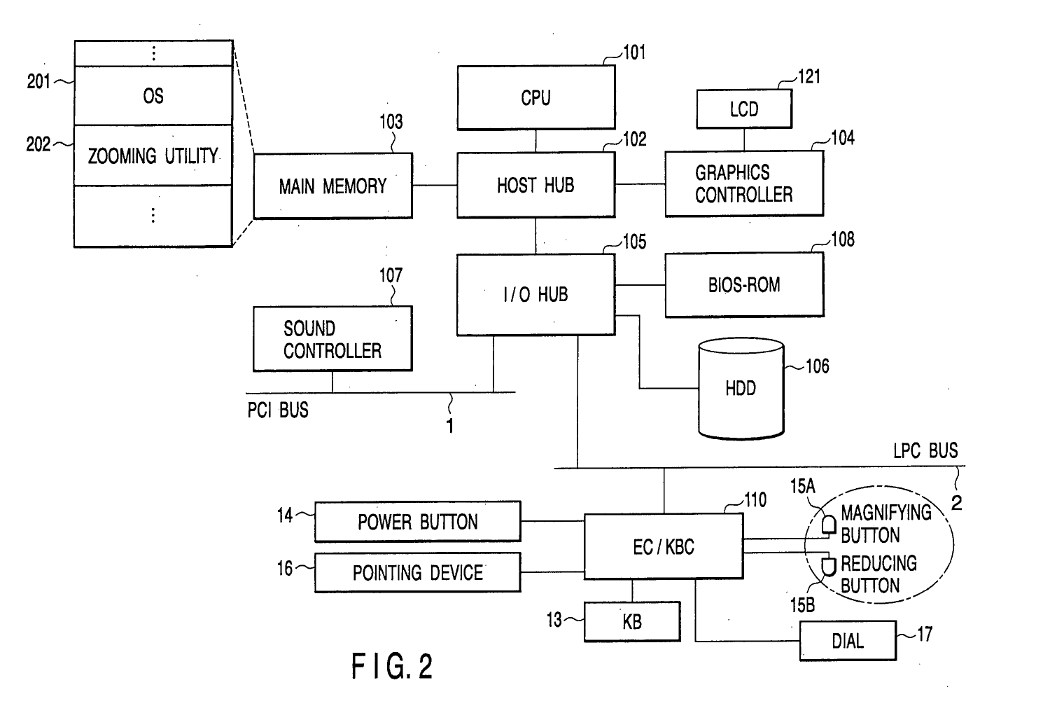

Referring to FIGS. 1 and 2, a configuration of information processing apparatus according to a first embodiment of the present invention will be described below. This information processing apparatus is realized, for example, by a notebook type personal computer 10.

The computer 10 comprises a computer main body 11 and a display unit 12. FIG. 1 shows a state in which the display unit 12 of the notebook type personal computer 10 is open. The display unit 12 incorporates a display device composed of an LCD (liquid crystal display) 121, and the display screen of the LCD 121 is positioned nearly in the center of the display unit 12.

The display unit 12 is mounted on the computer main body 11 so as to be pivotable between the opening position and the closing position. The computer main body 11 has a box-shaped casing, and its upper side features a keyboard 13, a power button 14 for turning on or off the power source of the computer 10, an input operation panel 15, and a touch pad 16.

The input operation panel 15 is an input device for inputting an event corresponding to a pressed button, and includes a plurality of buttons for starting multiple functions. The button group includes a magnifying button 15A and a reducing button 15B. The magnifying button 15A is a pushbutton switch for inputting a zoom event for instructing to magnify a content displayed in a window. The reducing button 15B is a pushbutton switch for inputting a zoom event for instructing to reduce the content displayed in the window. The magnifying and the reducing operation may be referred hereinafter as adjusting a sizing of content.

The window means certain display area displayed on the display screen and is associated with a running program. Each window usually has a title bar, menu bar, and a work region. The content displayed in the work region of the window is subject to magnification or reduction. The content displayed in the work region of the window includes characters as well as pictures including graphic images, and photo images. That is, each content displayed in the work region is intended to be adjusted the size.

The touch pad 16 is a pointing device for indicating the position on the display screen of the LCD 121, and indicates the position of a pointer such as mouse cursor or mouse pointer, displayed on the display screen. Depending on the manipulation of the touch pad 16, the pointer (hereinafter “mouse cursor”) displayed on the display screen is moved on the display screen.

In the first embodiment, by input of the zoom event, the window (also called “application window”) positioned under the current position of the mouse cursor on the display window is detected automatically, and the content displayed in the detected window is magnified or reduced. More specifically, when the magnifying button 15A is pressed, the display size of elements, i.e. characters and/or pictures, composing the content displayed in the window positioned under the current position of the mouse cursor is magnified. When the reducing button 15B is depressed, the display size of elements, i.e. characters and/or pictures, composing the content displayed in the window positioned under the current position of the mouse cursor is reduced. In this embodiment, the desktop screen is also handled as one of windows. If the current position of the mouse cursor is on the desktop screen, the display size of each icon which includes the icon image and the text showing the icon name, disposed on the desktop screen is also adjusted as magnified or reduced.

In the environment of display of plural windows on the LCD 121, the user often manipulates to input data such as a command and text on the active window while observing the content of other inactive windows. The active window is the window presently subject to input of command or text. The active window is displayed in the foremost screen. When a certain window is clicked by manipulation of the touch pad 16, the clicked window is a new active window. However, if the mouse cursor is merely moved from the active window to an inactive window without click, the active window is not changed over.

In this embodiment, the window whose content is magnified is the window positioned under the current position of the mouse cursor. Hence, without changing the active window, the content may be magnified or reduced not only on the active window but also on a inactive window.

At a side face of the computer main body 11, a dial 17 is rotatably provided. The dial 17, same as the magnifying button 15A and reducing button 15B, functions as an input device for inputting a zoom event. The dial 17, depending on its rotating direction, inputs a zoom event for instructing either magnification or reduction of the content in the window.

Referring next to FIG. 2, the system configuration of the computer 10 will be explained. The computer 10 comprises a CPU 101, a host hub 102, a main memory 103, a graphics controller 104, an I/O hub 105, a hard disk drive (hereinafter “HDD”) 106, a sound controller 107, a BIOS-ROM 108, an embedded controller/keyboard controller IC (hereinafter “EC/KBC”) 110, and the like.

The CPU 101 is a processor provided for controlling the operation of the computer 10, and executes an operating system (hereinafter “OS”) 201 and various application/utility programs loaded from the HDD 106 into the main memory 103. The OS 201 has a software-based window system for displaying a plurality of windows on the display screen. The CPU 101 also executes the Basic Input Output System (hereinafter “BIOS”) stored in the BIOS-ROM 108.

In this computer 10, a zooming utility program 202 is installed as one of utility programs. This zooming utility program 202 is a program for executing the zoom process for magnifying or reducing the content in the window. The zooming utility program 202 is starting up automatically, for example, when the computer 10 is started up. The zooming utility program 202 can be realized, for example, as terminate-and-stay resident program, so-called TSR.

The host hub 102 is a bridge device for connecting between the local bus of the CPU 101 and the I/O hub 105. The host hub 102 incorporates a memory controller for access control of the main memory 103. The graphics controller 104 controls the LCD 121 used as a display monitor of the computer 10. The graphics controller 104 has a video memory (hereinafter “VRAM”), and displays the display data drawn in the video memory by the OS and/or application program in the LCD 121.

The I/O hub 105 controls each device on the peripheral component interconnect (hereinafter “PCI”) bus 1 and each device on the low pin count (hereinafter “LPC”) bus 2. The I/O hub 105 also incorporates an integrated drive electronics (hereinafter “IDE”) controller for controlling the HDD 106.

The sound controller 107 is provided on the PCI bus 1. The sound controller 107 is a PCI device functioning as sound source. On the LPC bus 2, the EC/KBC 110 is provided.

The EC/KBC 110 is a one-chip microcomputer integrating an embedded controller for power management, and a keyboard controller for controlling the keyboard 13 and the touch pad 16 that is the pointing device. The EC/KBC 110 has a function of turning on or off the power of the computer 10 depending on manipulation of the power button 14 by the user.

Further, the EC/KBC 110 has a function of detecting the depressing manipulation of the magnifying button 15A and reducing button 15B by the user, and a function of detecting the rotating manipulation of the dial 17 by the user.

When the magnifying button 15A is depressed, the EC/KBC 110 notifies the zooming utility program 202 of the occurrence of the zoom event, i.e. magnifying event, for instructing to magnify the content displayed in the window by using, for example, an interrupt signal to the CPU 101. When the reducing button 15B is depressed, the EC/KBC 110 notifies the zooming utility program 202 of the occurrence of the zoom event, i.e. reducing event, for instructing to reduce the content displayed in the window by using, for example, an interrupt signal to the CPU 101. When the dial 17 is rotated, similarly, the EC/KBC 110 notifies the zooming utility program 202 of the occurrence of the magnifying event or reducing event depending on the rotating direction of the dial 17 by using, for example, an interrupt signal to the CPU 101.

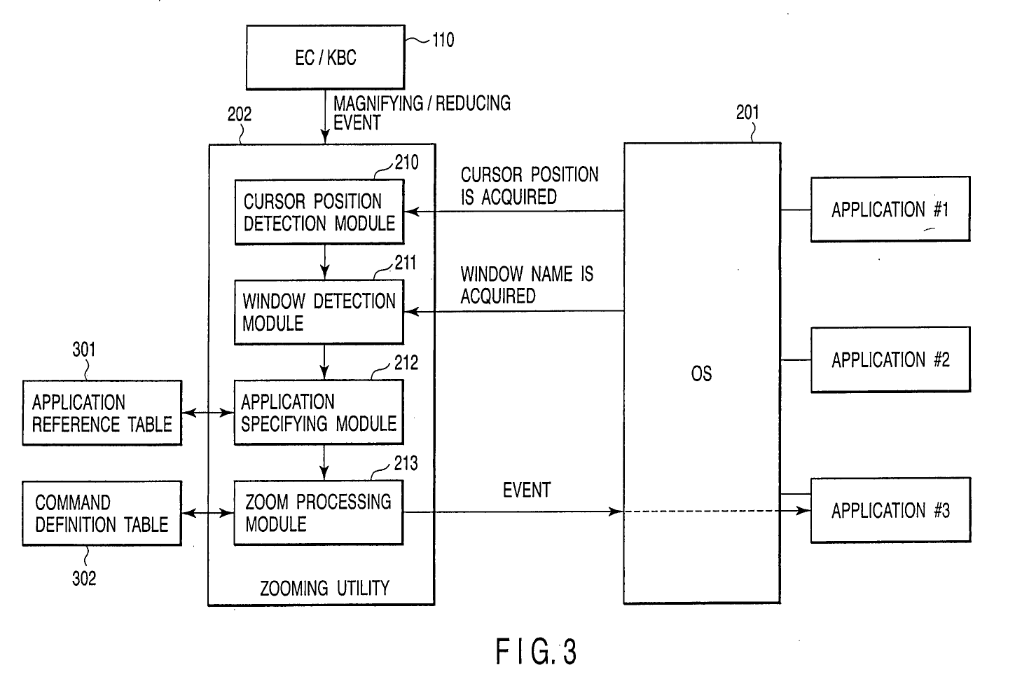

Referring to FIG. 3, the configuration of the zooming utility program 202 will be explained.

The zooming utility program 202 includes a cursor position detection module 210, a window detection module 211, an application-specifying module 212, and a zoom process module 213.

The cursor position detection module 210 and window detection module 211 are used for searching the window existing under the current position of the mouse cursor moving on the display screen according to manipulation of the touch pad 16.

The cursor position detection module 210 is a module for detecting the current position, e.g. XY coordinates, of the mouse cursor. When occurrence of the magnifying or reducing zoom event is notified from the EC/KBC 110, the cursor position detection module 210 acquires the current cursor position, from the OS 201, whereby the current position of the mouse cursor is detected. The window detection module 211 is a module for detecting the window existing under the detected current position of the mouse cursor. The window detection module 211 inquires the OS 201 of the name of the window existing under the detected current cursor position, thereby acquiring the name of the window existing under the detected current mouse cursor position from the OS 201. Also, by comparing the position of each window existing on the display screen, e.g. XY coordinates at the upper left end of the window, and window size, with the detected current mouse cursor position, the name of the window existing under the current mouse cursor position can be detected.

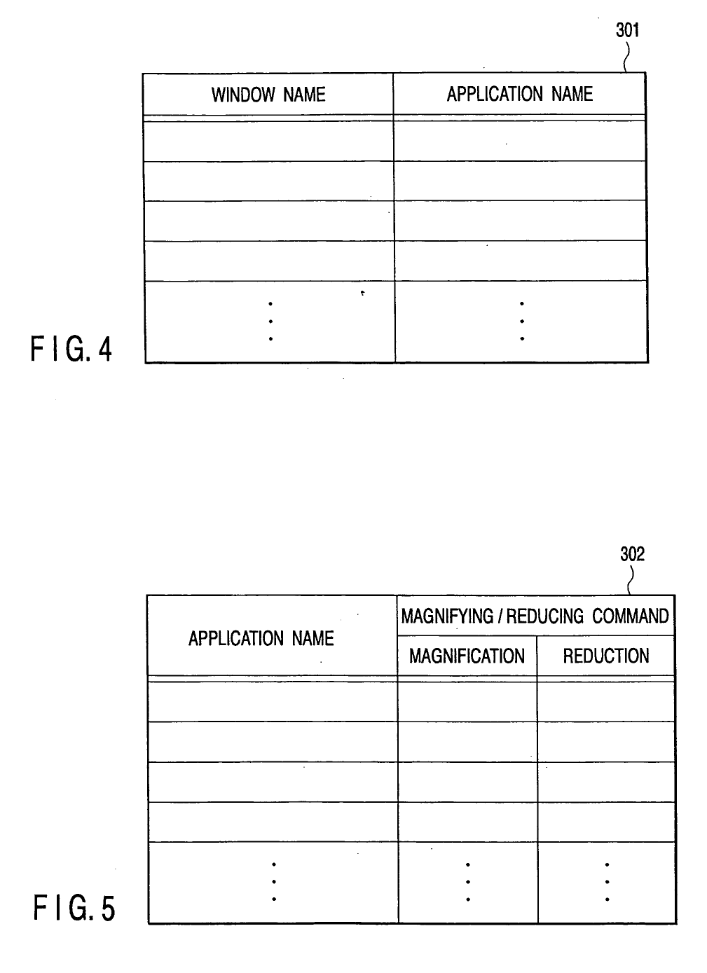

The application-specifying module 212 is a module for specifying an application program corresponding to the window existing under the current position of the mouse cursor. This application-specifying module 212 refers to an applicable reference table 301, and specifies the application program corresponding to the window detected by the window detection module 211. The application reference table 301 defines the application program name corresponding to the window name for each window name as shown in FIG. 4.

The zoom processing module 213 is a module for executing zoom process for magnifying or reducing the content displayed in the window detected by the window detection module 211. The zoom processing module 213 makes use of the zoom function of magnifying or reducing the content, the function being possessed by each application program, and executes the zoom process. An event or message for starting up the zoom function of the application program differs for each application program. Accordingly, the zoom processing module 213 refers to a command definition table 302, and executes the command process differing for each application program.

The command definition table 302 defines the magnifying command and reducing command corresponding to the application program for each application program name as shown in FIG. 5. The magnifying command shows an event for starting up the zoom function, magnifying, of the corresponding application program, and the reducing command shows an event for starting up the zoom function, reducing, of the corresponding application program. An event is expressed by a code showing combination of multiple keys such as “Ctrl+PageUp” and “Ctrl+PageDown.”

The zoom processing module 213 issues a magnifying/reducing command corresponding to the application program specified by the application specifying module 212, to the specified application program, as an event for starting up the zoom function possessed by the specified application program.

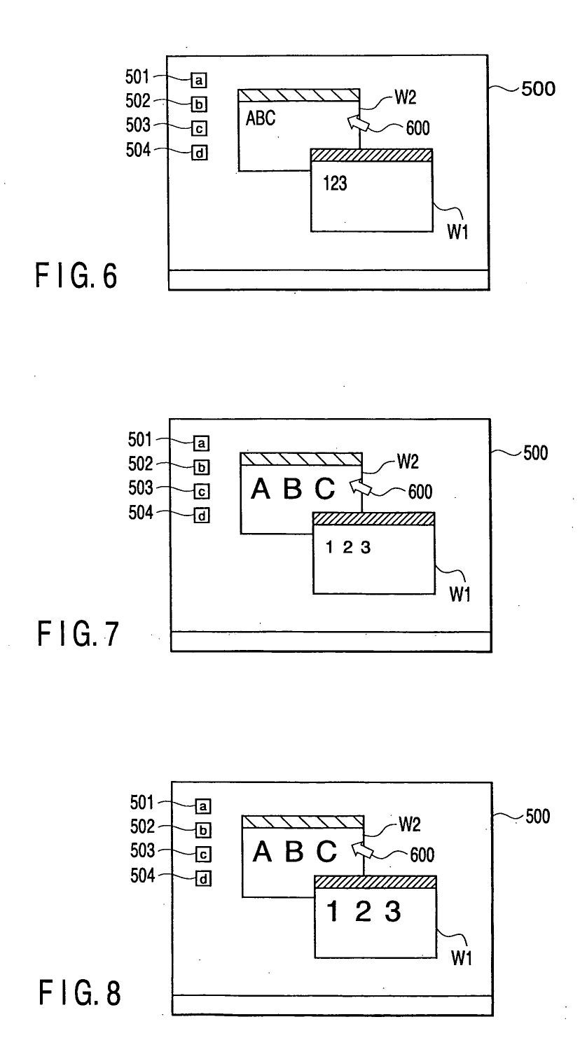

Referring now to FIGS. 6 to 13, the magnifying and reducing manner of the content of the window or the icon will be explained below.

FIG. 6 shows an example of the display screen of the LCD 121. The display screen of the LCD 121 displays a desktop screen 500. On the desktop screen 500, icon groups 501 to 504 are disposed. Two windows W1 and W2 are also displayed on the desktop screen 500. Contents such as characters and pictures are displayed in the work regions of the windows W1 and W2. In FIG. 6, the window W1 is the active window, and the window W2 is the inactive window. The window W1 is displayed in the foremost side, and the text or the like inputted from the keyboard 13 is displayed in the window W1. A mouse cursor 600 may be moved at an arbitrary position on the display screen depending on manipulation of the touch pad 16 of FIG. 1 by the user.

In a state in which the inactive window W2 is present immediately beneath the mouse cursor 600, when the magnifying button 15A is depressed, the content in the window W2 is magnified. A magnified display screen is shown in FIG. 7. As shown in FIG. 7, the display size of the content such as characters displayed in the window W2 is magnified. If a picture such as a graphic image is present as the content in the window W2, the display size of the picture is also magnified. The window size of the window W2 is not changed in this embodiment. The window W1 remains to be an active window. Every time the magnifying button 15A is depressed, the content in the window W2, that is, the display size of the content displayed in the window W2 is magnified gradually at a predetermined scaling factor.

These operations are performed in the same way even though the numbers of windows displayed on the display screen are three or more.

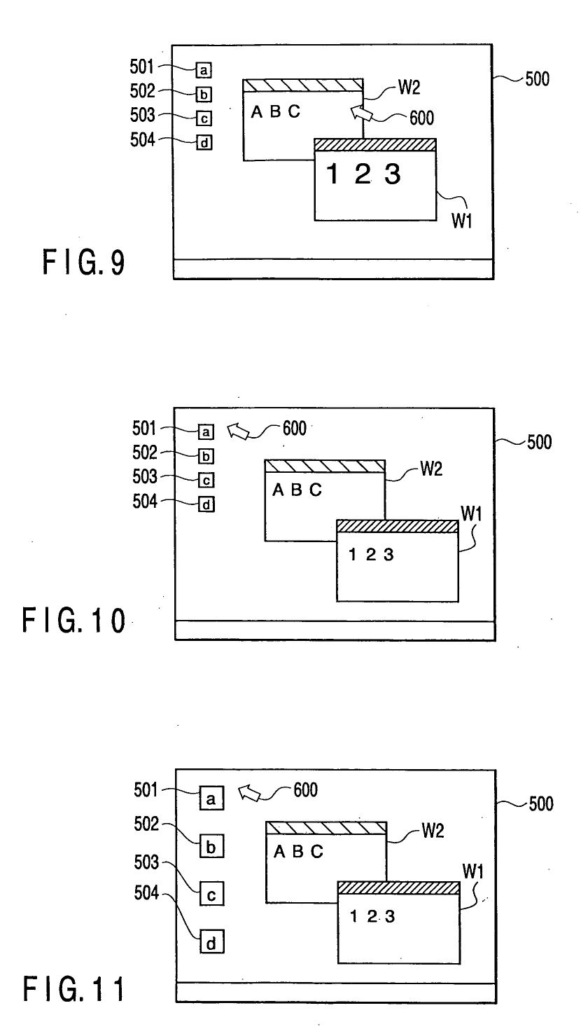

FIGS. 8 and 9 show a mode of reduction of the display size in the window. As shown in FIG. 8, when the reducing button 15B is depressed while the inactive window W2 is present immediately beneath the mouse cursor 600, the content displayed in the window W2 is reduced. FIG. 9 shows the display screen that the reducing operation to the window W2 has been performed. The window size of the window W2 is not changed in this embodiment. The window W1 still remains to be an active window. Every time the reducing button 15B is depressed, the content in the window W2 is reduced gradually at a predetermined scaling factor.

These operations are performed in the same way even though the numbers of windows displayed on the display screen are three or more.

Thus, in this embodiment, without changing over the active window, the display size of the contents displayed in an arbitrary inactive window may be magnified or reduced.

FIGS. 10 and 11 show a mode of magnification of the content on the desktop screen 500. As shown in FIG. 10, when the magnifying button 15A is depressed while the desktop screen 500 is present immediately beneath the mouse cursor 600, the display size of the icons 501 to 504 on the desktop screen 500 is magnified. FIG. 11 shows the display screen that the icons 501 to 504 have been magnified. Every time the magnifying button 15A is depressed, the display size of the icons 501 to 504 is magnified gradually at a predetermined scaling factor.

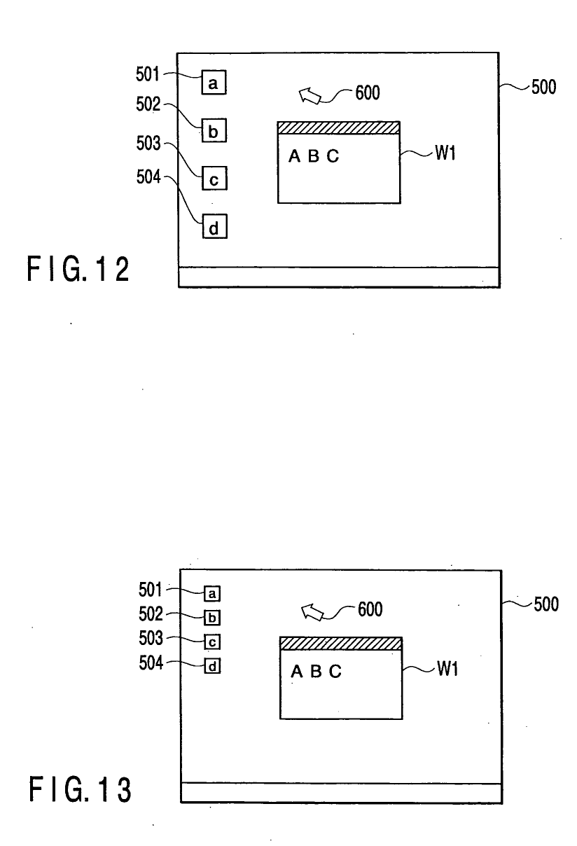

FIGS. 12 and 13 show a mode of reduction of the display image on the desktop screen 500. As shown in FIG. 12, when the reducing button 15B is depressed while the desktop screen 500 is present immediately beneath the mouse cursor 600, the display size of the icons 501 to 504 on the desktop screen 500 is reduced. FIG. 13 shows the display screen that icons 501 to 504 have been reduced. Every time the reducing button 15B is depressed, the display size of the icons 501 to 504 is reduced gradually at a predetermined scaling factor.

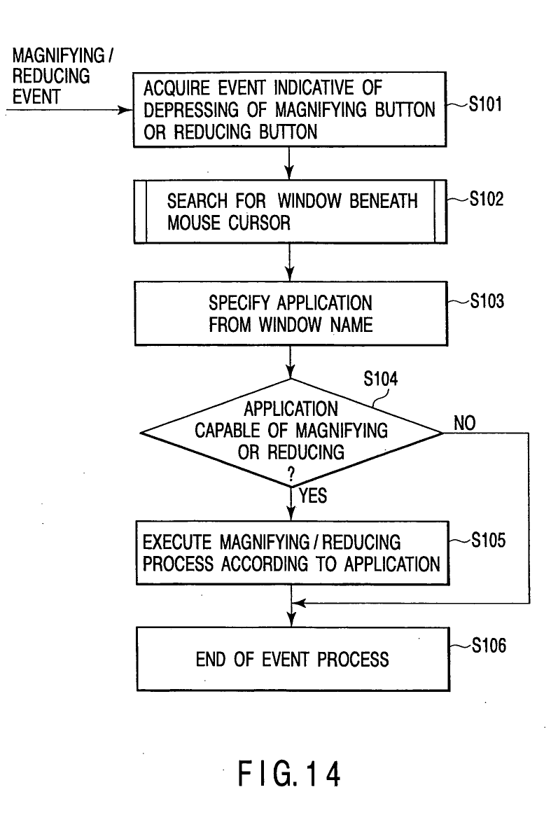

Referring to the flow chart in FIG. 14, the procedure of the process executed by the CPU 101 of FIG. 2 under the control of the zooming utility program 202 of FIG. 2 will be explained.

When the magnifying button 15A or reducing button 15B is depressed, the CPU 101 acquires a zoom event indicative of the depression of the magnifying button 15A or reducing button 15B from the KBC 110 (operation S101). The CPU 101 processes as follows by executing the zooming utility program 202.

First, the CPU 101 searches for a window existing under the current position of the mouse cursor (operation S102). In the S102, the current position of the mouse cursor is detected first, and then the window name of the window existing under the current position of the mouse cursor is detected.

The CPU 101 refers to the application reference table 301 of FIG. 4, and thereby specifies the application program corresponding to the window name detected in the operation S102 (operation S103). In consequence, the CPU 101 (see FIG. 2) determines whether or not the application program corresponding to the detected window name is an application program capable of magnifying or reducing by the zooming utility program 202 (operation S104). The application program of which application program name is stored in the application reference table 301 is an application program capable of magnifying or reducing by the zooming utility program 202, and the application program of which application program name is not stored herein is an application program not capable of magnifying or reducing by the zooming utility program 202.

If the application program corresponding to the detected window name is not an application program capable of magnifying or reducing (No in operation S104), the CPU 101 terminates the execution of the process corresponding to the zoom event (operation S106).

On the other hand, when the application program corresponding to the detected window name is an application program capable of magnifying or reducing by the zooming utility program 202 (Yes in operation S104), the CPU 101 executes the magnifying or reducing process corresponding to the application program (operation S105).

In the operation S105, the CPU 101 acquires the magnifying or reducing command corresponding to the application program name specified in the operation S103 from the command definition table 302. The CPU 101 sends the event instructed by the acquired magnifying or reducing command to the application program specified in operation S103 directly or through the OS 201 of FIG. 2. As a result, the zoom function of the application program is executed, and the display size of the contents for composing the display image in the window corresponding to the application program is magnified or reduced.

Depending on application programs, the event for starting up the zoom function of the application program may not be defined. In such a case, a process may be executed for rewriting the environment setting information of the application program specified in the operation S103. The environment setting information includes the environment setting information showing the display size of characters, and environment setting information showing the display size of the image.

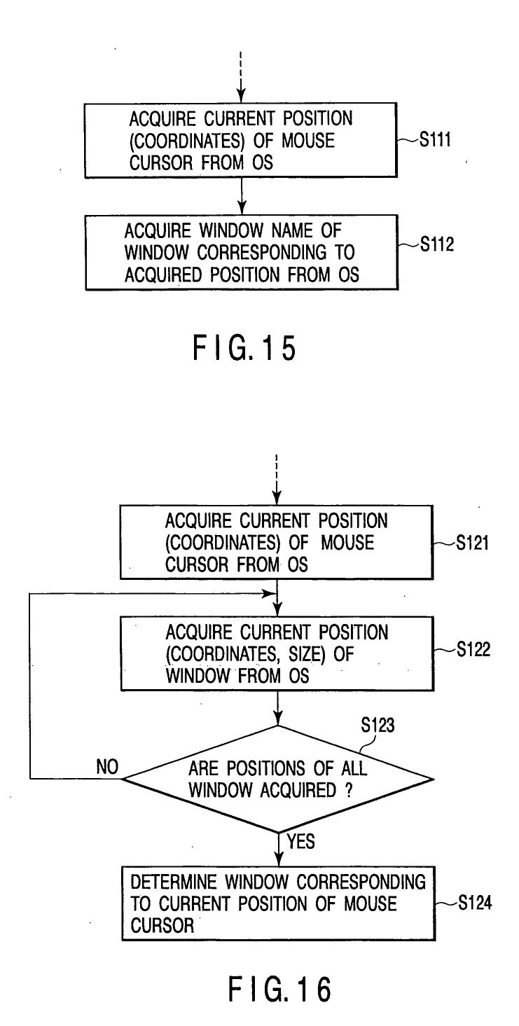

A flow chart in FIG. 15 shows a specific procedure executed in the operation S102 in FIG. 14.

The CPU 101 inquires the OS 201 of the current position of the mouse cursor, and acquires the current position of the mouse cursor from the OS 201 (operation S111). Further, the CPU 101 inquires the OS 201 of the window name, e.g., window handle, existing immediately beneath the current position of the mouse cursor, and acquires the window name from the OS 201 (operation S112).

A flow chart in FIG. 16 shows another example of a specific procedure executed in the operation S102 in FIG. 14.

The CPU 101 inquires the OS 201 of the current position of the mouse cursor, and acquires the current position of the mouse cursor from the OS 201 (operation S121). Subsequently, the CPU 101 acquires the current position of all windows disposed on the display screen from the OS 201 (operations S122, S123). The current position of all windows is, in this embodiment, indicated as XY coordinates at the upper left end of window, and window size. The CPU 101 compares the current position of each window and the current position of the mouse cursor, and determines the window existing immediately beneath the current position of the mouse cursor (operation S124).

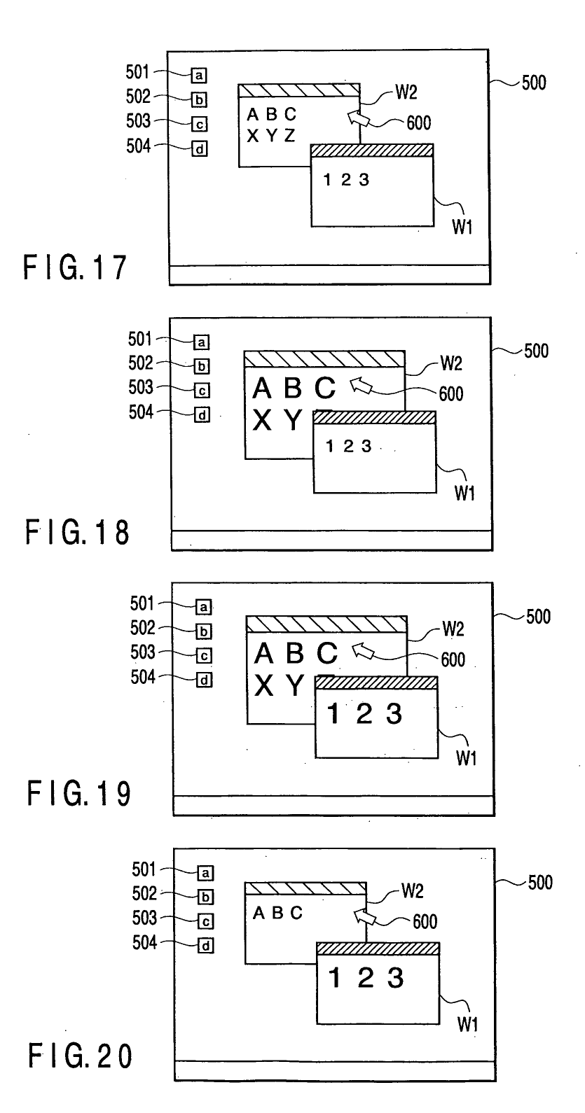

Referring to FIGS. 17 to 20, a second embodiment will be explained. In the second embodiment, the system magnifies or reduces the window size, as well as the content displayed in the window existing under the current position of the mouse cursor. The other parts in the second embodiment than adjusting the window size are the same as the first embodiment.

When only the content in the window is magnified while maintaining the size of the window, part of characters and pictures displayed before magnification may not be fully displayed after magnification. When magnifying the content displayed in the window, by magnifying also the window size according to the magnification factor of the content, the characters and pictures displayed before magnification of the content may be fully displayed after magnification of the content.

As shown in FIG. 17, when the magnifying button 15A is depressed while the inactive window W2 is present immediately beneath the mouse cursor 600, the content in the window W2 is magnified, and also the window size of the window W2 is magnified. FIG. 18 shows the display screen that the window W2 and the content in the window W2 have been magnified. As shown in FIG. 18, the display size of the content such as characters in the window W2 is magnified. If a picture such as a graphic image is present as the content in the window W2, the display size of the picture is also magnified. Further, the window W2 is resized such that the window size of the window W2 is magnified at the same scaling factor as that to the content in the window W2.

As shown in FIG. 19, when the reducing button 15B is depressed while the inactive window W2 is present immediately beneath the mouse cursor 600, the content displayed in the window W2 is reduced, and the window size of the window W2 is also reduced. FIG. 20 shows the display screen that the window W2 and the content in the window W2 have been reduced. As shown in FIG. 20, the display size of the content such as characters in the window W2 is reduced. If a picture such as a graphic image is present as the content in the window W2, the display size of the picture is also reduced. Further, the window W2 is resized such that the window size of the window W2 is reduced at the same scaling factor as that to the content in the window W2.

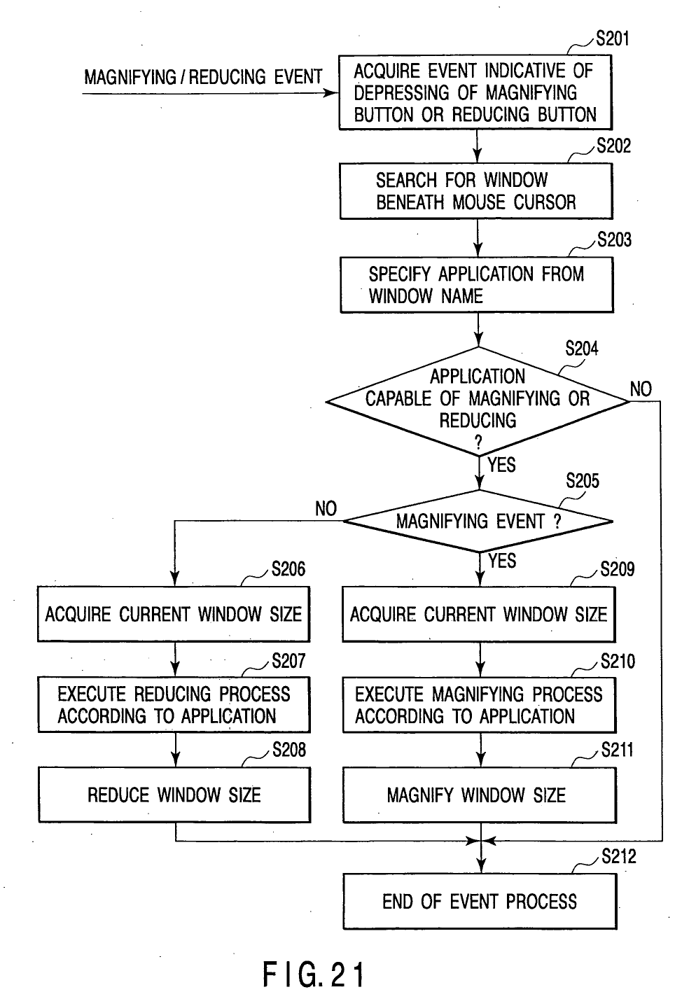

Referring next to a flow chart in FIG. 21, the procedure is explained about magnification or reduction of content in a window and window size executed by the CPU 101 of FIG. 2 under the control of the zooming utility program 202 of FIG. 2.

When the magnifying button 15A or reducing button 15B is depressed, the CPU 101 acquires a zoom event indicative of manipulation of the magnifying button 15A or reducing button 15B from the KBC 110 (operation S201). The CPU 101 processes as follows by executing the zooming utility program 202.

First, the CPU 101 searches for a window existing under the current position of the mouse cursor (operation S202). In the operation S202, the current position of the mouse cursor is detected first, and then the window name of the window existing under the current position of the mouse cursor is detected.

The CPU 101 refers to the application reference table 301, and thereby specifies the application program corresponding to the window name detected in the operation S202 (operation S203). In consequence, the CPU 101 determines whether or not the application program corresponding to the detected window name is an application program capable of magnifying or reducing by the zooming utility program 202 (operation S204).

The application program of which application program name is stored in the application reference table 301 of FIG. 4 is an application program capable of magnifying or reducing by the zooming utility program 202. On the other hand, the application program of which application program name is not stored herein is an application program not capable of magnifying or reducing by the zooming utility program 202 of FIG. 2.

If the application program corresponding to the detected window name is an application program capable of magnifying or reducing (Yes in the operation S204), the CPU 101 determines whether the zoom event is a magnifying event or a reducing event (operation S205).

If the zoom event is a reducing event (No in the operation S205), the CPU 101 acquires the window size of the window detected in the operation S202 from the OS 201 of FIG. 2, and detects the window size of the window (operation S206). The CPU 101 executes the reducing process corresponding to the application program specified in the operation S203 (operation S207).

In the operation S207, the CPU 101 acquires the reducing command corresponding to the application program name specified in the operation S203 from the command definition table 302. The CPU 101 sends the event indicated by the acquired reducing command to the application program specified in the operation S203 directly or by way of the OS 201. As a result, the zoom function of the application program is executed, and the content in the window corresponding to the application program is reduced.

Next, in order to reduce the window size of the window detected in the operation S202 according to the reduction factor of the content, the CPU 101 executes the resize process for reducing the window size of the window detected in the operation S202 (operation S208). In the operation S208, the CPU 101 calculates the window size after resizing from the window size acquired in the operation S205 and the reduction factor of the content. The CPU 101 requests the resize process for the window detected in the operation S202 to the OS 201 such that the window size of the window detected in the operation S202 conforms to the calculated size.

On the other hand, if the zoom event is a magnifying event (Yes in the operation S205), the CPU 101 acquires the window size of the window detected in the operation S202 from the OS 201, and detects the window size of the window (operation S209). The CPU 101 executes the magnifying process corresponding to the application program specified in the operation S203 (operation S210).

In the operation S210, the CPU 101 acquires the magnifying command corresponding to the application program name specified in the operation S203 from the command definition table 302. The CPU 101 sends the event indicated by the acquired magnifying command to the application program specified in the operation S203 directly or by way of the OS 201. As a result, the zoom function of the application program is executed, and the content in the window corresponding to the application program is magnified.

Next, in order to magnify the window size of the window detected in the operation S202 according to the magnification factor of the content, the CPU 101 executes the resize process for magnifying the window size of the window detected in the operation S202 (operation S211). In the operation S211, the CPU 101 calculates the window size after resizing from the window size acquired in the operation S209 and the magnification-scaling factor of the content. The CPU 101 requests the resize process to the OS 201 such that the window size of the window detected in the operation S202 conforms to the calculated size.

If the OS 201 has a function of resizing the window size in accordance with the magnification or reduction factor specified by the parameter included in the resize request, it is not required to calculate the window size after resizing. Hence, the processes in the operation S206 and the operation S209 may be skipped in such case.

In the foregoing explanation, the magnifying and reducing buttons 15A, 15B, and the dial 17 are used as devices for inputting a zoom event, but a specific combination of keys on the keyboard 13 may be also used as a zoom event. Also, for example, depending on the button manipulation of the touch pad 16, a menu screen for selecting one of plural functions including execution of zoom event may be displayed on the display screen.

A computer program realizes the magnifying or reducing function of the first and second embodiment, and when such a computer program is installed in an ordinary computer using a computer-readable recording medium, the same effects as in the first and second embodiment may be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus, comprising:
a display adapted to display a display area thereon, the display area being associated with a running program and being either active or inactive;
a first user interface to detect an event representing a request to adjust a sizing of content displayed within the display area;
a second user interface to receive data indicating a position of a pointer when the first user interface detects the event; and
a control unit configured to adjust the sizing of the content in response to detection of the event by the first user interface in the case that the position of the pointer that the second user interface receives is in the display area, regardless of whether the display area is active or inactive.

2. An information processing apparatus according to claim 1, wherein the display is able to display two or more display areas at the same time.

3. An information processing apparatus according to claim 2, wherein the control unit comprises means for specifying one of display areas corresponding to the pointer's position.

4. An information processing apparatus according to claim 3, wherein the control unit comprises means for issuing an event for starting to adjust the sizing of the content in the display area specified by the specifying means.

5. An information processing apparatus according to claim 1, wherein the control unit comprises means for adjusting the size of the display area corresponding to the position of the pointer at a predetermined scaling factor.

6. An information processing apparatus according to claim 5, wherein the predetermined scaling factor is the same as applied to the content within the display area.

7. An information processing apparatus according to claim 1, further comprising means for acquiring information indicating the position of the pointer and the position of the display area.

8. An information processing apparatus according to claim 7, further comprising means for detecting that the position of the pointer is in the display area on the basis of the information indicating the position of the pointer and the position of the display area.

9. An information processing apparatus according to claim 1, wherein the event comprises a first event for instructing magnification of the content, and a second event for instructing reduction of the content.

10. A method comprising:
displaying a display area on a display, the display area being associated with a running program and being either active or inactive;
detecting an event representing a request to adjust a sizing of content displayed within the display area;
receiving data indicating a position of a pointer when detecting the event; and
adjusting the sizing of the content in response to detecting the event in the case that the cursor position is in the display area, regardless of whether the display area is active or inactive.

11. A method according to claim 10, wherein the display is adapted to display two or more display areas at the same time.

12. A method according to claim 11, further comprising specifying one of display areas corresponding to the position of the pointer.

13. A method according to claim 12, further comprising issuing an event for starting to adjust the sizing of the content in the display area specified.

14. A method according to claim 10, further comprising adjusting the size of the display area corresponding to the position of the pointer at a predetermined scaling factor.

15. A method according to claim 14, wherein the predetermined scaling factor is the same as applied to the content within the display area.

16. A method according to claim 10, further comprising acquiring information indicating the position of the pointer and the position of the display area.

17. A method according to claim 16, further comprising detecting that the position of the pointer is in the display area on the basis of the information indicating the position of the pointer and the position of the display area.

18. A computer readable recording medium that records a program, the program when executed by the computer causing the computer to execute the operations comprising:
detecting an event representing a request to adjust a sizing of content displayed within a display area which is associated with a running program and is either active and inactive;
receiving data indicating a position of a pointer when detecting the event; and
adjusting the sizing of the content in response to detecting the event in the case that the position of the pointer is in the display area, regardless of whether the display area is active or inactive.

19. A computer readable recording medium according to claim 18, further comprising specifying one of display areas corresponding to the position of the pointer, and issuing an event for starting to adjust the sizing of the content in the display area specified.

20. An information processing apparatus, comprising:
means for displaying a display area, the display area being associated with a running program and being either active or inactive;
means for detecting an event representing a request to adjust a sizing of content displayed within the display area;
means for receiving data indicating a position of a pointer when the means for detecting detects the event; and
means for adjusting the sizing of the content in response to detection of the event by the means for detecting in the case that the position of the pointer that the means for receiving receives is in the display area, regardless of whether the display area is active or inactive.
